(19) United States
(12) Patent Application Publication
(10) Pub. No.: US 2025/0361162 A1
(43) Pub. Date: Nov. 27, 2025

(54) REDUCTION IN TRIHALOMETHANE FORMATION USING STABILIZED HALOGEN BIOCIDES

(71) Applicant: CHEMTREAT, INC., Glen Allen, VA (US)

(72) Inventors: Douglas MCILWAINE, Ashland, VA (US); Rajendra Prasad KALAKODIMI, Glen Allen, VA (US); Benjamin NIEMASECK, Chesterfield, VA (US)

(73) Assignee: CHEMTREAT, INC., Glen Allen, VA (US)

(21) Appl. No.: 19/214,810

(22) Filed: May 21, 2025

Related U.S. Application Data
(60) Provisional application No. 63/650,245, filed on May 21, 2024.

(51) Int. Cl. C02F 1/50; A01N 59/00; A01P 1/00; C02F 101/36; C02F 103/02

(52) U.S. Cl. CPC C02F 1/50; A01N 59/00; A01P 1/00; C02F 2101/36; C02F 2103/023; C02F 2209/20; C02F 2303/04

(57) ABSTRACT

Methods for treating water in a water system to reduce the amount of trihalomethanes (“THM”) in the water. The methods include combining with the water a stabilized halogen biocide that is stabilized with at least one of sulfamic acid and a hydantoin in sufficient amounts so that the water has a residual total halogen amount that is from 0.1 ppm to 50 ppm, for example. The THM in the treated water can be significantly reduced as compared to treatments in which hypochlorous acid and/or hypobromous acid are the only antimicrobial agents.

### CROSS-REFERENCE TO RELATED APPLICATIONS

This application claims the earlier filing date benefit of U.S. Provisional Application No. 63/650,245, which was filed on May 21, 2024, the entirety of which is incorporated by reference herein.

### BACKGROUND

The use of hypochlorous and hypobromous acids as antimicrobials in industrial cooling water systems is extremely effective but can give rise to trihalomethane (“THM”) formation, such as chloroform and bromoform. These disinfection by-products form when the halogen based antimicrobial reacts with organic species in the water.

THMs are considered toxic to humans, and discharge of THMs in industrial water systems is regulated by law in many jurisdictions.

### SUMMARY

In connection with this disclosure, the inventors have found that using stabilized halogens in water systems with a certain amount of total organic carbon (TOC) can significantly decrease the amount of THM's formed as compared to the amount of THM's formed when hypobromous or hypochlorous acids are used.

According to one aspect, this disclosure provides a method for treating water in a water system in which the water has a TOC content of greater than 5 ppm, including steps of combining with the water a sufficient amount of a stabilized halogen biocide that is stabilized with at least one of sulfamic acid and a hydantoin so that the stabilized halogen biocide is present in the water in amounts of from 0.1 to 50 ppm total halogen residual. The water that is treated with the stabilized halogen biocide can form a total amount of THMs (as chloroform, bromoform, dichlorobromomethane, and dibromochloromethane) that is less than 200 ppb.

According to another aspect, this disclosure provides a method for treating water in an open-recirculating water system in which at least one of hypochlorous acid and hypobromous acid are combined with the water as an antimicrobial agent and the water has a first amount of trihalomethanes as chloroform, bromoform, dichlorobromomethane, and dibromochloromethane. The method includes (i) reducing an amount of the hypochlorous acid and/or hypobromous acid that is combined with the water; and (ii) combining with the water a sufficient amount of a stabilized halogen biocide that is stabilized with at least one of sulfamic acid and a hydantoin so that the stabilized halogen biocide is present in the water in amounts of from 0.1 to 50 ppm total halogen residual. The water that is treated with the stabilized halogen biocide has a total amount of the trihalomethanes that is 65% or less than the aforementioned first amount.

### DETAILED DESCRIPTION

This disclosure relates to treating water systems prone to THM formation with halogen biocides that are stabilized with either sulfamic acid or a hydantoin such as dimethylhydantoin. It is known that the use of monochloramine or chlorine dioxide will not lead to significant increases in THM formation. It is believed that this result is due to the fact that these antimicrobials exhibit reactivity that is significantly different from the reactivity of hypochlorous acid or hypobromous acid. This difference in reactivity is due to the oxidation state of chlorine in monochloramine and chlorine dioxide, versus hypochlorous acid or hypobromous acid. Monochloramine is very stable and thus is persistent, whereas hypochlorous acid and hypobromous acid are much more reactive. While the increased reactivity of these halogen biocides is beneficial from an antimicrobial perspective, it can also lead to unwanted side reactions such as the formation of THM. The decreased reactivity of monochloramine means that higher concentrations of it must be used relative to hypochlorous acid or hypobromous acid.

It has been discovered in connection with this disclosure that the formation of THMs are particularly problematic in water systems that are both (i) treated with hypochlorous and/or hypobromous acid; and (ii) include relatively high amounts of organics in the water (TOC). By way of example, relatively high levels of TOC might be present in some open-recirculating systems (such as cooling water systems) if the system takes in large amounts of dust, pollen, dirt, and other organic matter from the air, or if the makeup water to the system is a surface water source. It has been discovered that the formation of THM in these water systems can be significantly reduced by treating the water with a stabilized halogen, together with a reduction or replacement of hypobromous acid and/or hypochlorous acid treatment. The use of stabilized halogen biocides and the reduction of THMs is particularly useful in water systems that discharge water to a surface waterway since those discharge points will likely have regulated concentrations of THMs. In other embodiments, the stabilized halogen biocides can be used in water systems that discharge water to a sanitary sewer (publicly owned treatment works).

The use of the stabilized halogen reduces the overall reactivity of the biocide, leading to fewer unwanted side reactions. Further, the stabilization of hypochlorous acid or hypobromous acid using either sulfamic acid or the dimethylhydantoin does not change the oxidation state of halogen, and the resulting stabilized halogen molecule releases the bromine or chlorine atom in the same oxidation state as it was prior to stabilization. Thus, the stabilization process decreases the unwanted side reactions while maintaining antimicrobial efficacy.

Halogens stabilized with sulfamic acid are commercially available and can be used as is. The stabilization of hypochlorous acid using 5,5-dimethylhydantoin can be performed in situ by mixing sodium hypochlorite with a hydantoin solution, which results in the formation of a chlorinated hydantoin molecule. The stabilization of hypobromous acid using 5,5-dimethylhydantoin can also be performed in situ by mixing sodium hypochlorite with sodium bromide and a hydantoin solution, which results in the formation of a brominated hydantoin molecule. Thus, in the case where the halogen is stabilized with hydantoin, the stabilized halogen can be formed on-site at the water system that is being treated. In such case, the stabilized halogen can be added to the water system soon after it is formed, e.g., less than 1 hour or less than 10 minutes. The use of the stabilized halogen antimicrobials results in fewer disinfection by-products, specifically THMs, relative to the amount formed if hypochlorous or hypobromous acids were used without stabilization.

According to this disclosure, the stabilized halogen can be added to water as a biocide to inhibit or reduce microbe growth. The stabilized halogen can be added to the water in an amount that is in a range of from 0.1 to 50 ppm total halogen residual, from 0.5 to 15 ppm total halogen residual, or from 1 ppm to 5 ppm total halogen residual, for example. The applied dosage needed to achieve these residual concentrations can be determined by first determining the halogen demand of the water system for the stabilized halogen. The stabilized halogen can be dosed continuously, periodically, or intermittently. For example, in some systems it may be effective to treat the water with slug doses of the stabilized halogen, e.g., once every 8 to 80 hours or once every 12 to 50 hours, or more frequently, for example.

As indicated above, the water that is treated with the stabilized halogen(s) as described herein can be present in open-recirculating systems with a high TOC content. These system may include cooling water applications or other industrial waters. The water that is treated can have relatively high quantities of various organic species that will react with hypochlorous acid or hypobromous acid to form THMs. These water systems may have a TOC content of greater than 5 ppm, such as from 6 ppm to 50 ppm, or from 7 ppm to 25 ppm, for example.

Treating the water with at least one of the above-identified stabilized halogen biocides (and without hypochlorous or hypobromous acid) results in an increase in the bromoform concentration in the treated water as compared to the untreated water that is less than 75%, less than 50%, or less than 10%, for example. Also, treating the water with these stabilized halogen biocides can result in an increase, as compared to the untreated water, of chloroform concentration in the treated water that is less than 20%, less than 10%, or less than 5%, for example. In other words, stabilized halogens can be effectively used in quantities that are effective to treat the system as a biocide, and produce a relatively small quantity of THMs.

Since it has been found that the stabilized halogens have a comparable microbial efficacy as hypobromous and hypochlorous acids, the stabilized halogens can be used to effectively treat water without the need to add hypobromous acid or hypochlorous acid. In water systems with high TOC content that are being treated only with hypochlorous and/or hypobromous acid as antimicrobials, the transition to primarily using the hydantoin or sulfamic acid-stabilized halogens can result in an amount of THM in the treated water that is 65% or less than the amount of THM's in the water being treated with hypochlorous and/or hypobromous acid alone, and in some cases 25% or less, or even 10% or less, for example. For example, in some case the total amount of THMs (based on total chloroform, bromoform, dichlorobromomethane, and dibromochloromethane) in water that is treated with only hypochlorous and/or hypobromous acid as antimicrobials may have a THM level that is 100 ppb or greater, 150 ppb or greater, 250 ppb or greater, or 350 ppb or greater. The water can be treated with the stabilized halogen(s) to reduce the total amount of THMs (based on total chloroform, bromoform, dichlorobromomethane, and dibromochloromethane) to less than 200 ppb, less than 100 ppb, less than 50 ppb, or less than 25 ppb, for example.

In some embodiments a combination of the stabilized halogen and hypobromous acid or hypochlorous acid can be used. The hypobromous acid and/or hypochlorous acid can be dosed in relatively small amounts (e.g., less than 1.5 ppm, less than 0.5 ppm, or less than 0.1 ppm total halogen) depending on the circumstances.

In one aspect, the dosing or treatment of the water with the stabilized halogen can be controlled based on the measured TOC content of the water. This may be desirable where the water source for the water system has a highly variable TOC content. For example, where the water source is from surface water, the TOC content may vary seasonally, week-to-week, or day-to-day. When the TOC levels are low (e.g., less than 3 ppm), it may be feasible to treat the water with hypobromous acid and/or hypochlorous acid without forming excessive levels of THMs. Similarly, when the TOC levels are at intermediate levels (e.g., perhaps 3 ppm to 10 ppm), it may be possible to use a combination of hypochlorous and/or hypobromous acid and stabilized halogens without forming excessive THM. Accordingly, in one aspect, the invention includes measuring the TOC content of water in the water system, and adjusting the amount of the stabilized halogen added to the water based on the measured TOC and adjusting the amount of hypobromous acid and/or hypochlorous acid to the water. This includes, for example, adjusting a ratio of the stabilized halogen to the hypobromous or hypochlorous acid in the water.

### EXAMPLE 1A

### THM Reduction Using Stabilized Halogen Experiment

Multiple cooling tower water samples were gathered and combined into one large sample. After thorough mixing, the water was aliquoted into 6 different flasks. Samples of the composite cooling tower water were used to determine the halogen demand for each biocide that was tested. The oxidizing biocides that were used were bleach, bleach/bromide mixed at a 1:1 mole ratio to achieve complete conversion of the hypochlorite to hypobromous acid, a stabilized bromine biocide that contained a mixture of bromosulfamate and chlorosulfamate, a chlorosulfamate biocide, and a chlorinated hydantoin biocide prepared by mixing a 2:1 mole ratio of 5,5-dimethylhydantoin with sodium hypochlorite (bleach). Each biocide was assayed to determine the concentration of active halogen, and then each biocide was added to a composite cooling tower water sample to achieve 1 ppm of total halogen. Once the demands were known, each flask was then inoculated with sufficient oxidizing biocide to achieve 1 ppm of total halogen and mixed thoroughly.

The treated flasks were assayed for halogen residuals soon after inoculation. Those results are shown below in Table 1.

TABLE 1
Halogen Residuals Twenty Minutes After Dosing

| | Free Halogen | Total Halogen |
|---|---|---|
| Sample | (ppm) | (ppm) |
| Bleach | 0.50 | 0.63 |
| Bleach/Bromide | 0.84 | 0.90 |
| Bromosulfamate/Chlorosulfamate | 0.72 | 1.02 |
| Chlorosulfamate product | 0.02 | 0.87 |
| Chlorinated hydantoin | 0.16 | 0.86 |
| (bleach/5,5-dimethylhydantoin) | | |
| Control (Untreated) | 0.00 | 0.00 |

Three days after the initial dosing of the samples, the halogen residuals were again measured. Those results are shown below in Table 2.

TABLE 2
Halogen Residuals Three Days After Dosing

| | Free Halogen | Total Halogen |
|---|---|---|
| Sample | (ppm) | (ppm) |
| Bleach | 0.01 | 0.05 |
| Bleach/Bromide | 0.00 | 0.02 |
| Bromosulfamate/Chlorosulfamate | 0.00 | 0.22 |
| Chlorosulfamate product | 0.01 | 0.64 |
| Chlorinated hydantoin | 0.01 | 0.23 |
| (bleach/5,5-dimethylhydantoin) | | |
| Control (Untreated) | 0.00 | 0.00 |

The samples were again dosed with the halogen biocides and residuals were measured again twenty minutes after dosing. Those results are shown in Table 3 below.

TABLE 3
Halogen Residuals Twenty Minutes After 2^{nd} Dose

| | Free Halogen | Total Halogen |
|---|---|---|
| Sample | (ppm) | (ppm) |
| Bleach | 0.84 | 1.01 |
| Bleach/Bromide | 1.03 | 1.10 |
| Bromosulfamate/Chlorosulfamate | 0.72 | 1.21 |
| Chlorosulfamate product | 0.01 | 0.95 |
| Chlorinated hydantoin | 0.89 | 1.24 |
| (bleach/5,5-dimethylhydantoin) | | |
| Control (Untreated) | 0.00 | 0.00 |

After another 48 hours, the halogen residuals of the treated samples were measured, and those results are shown below in Table 4.

TABLE 4
Halogen Residuals Two Days After 2^{nd} Dose

| | Free Halogen | Total Halogen |
|---|---|---|
| Sample | (ppm) | (ppm) |
| Bleach | 0.02 | 0.12 |
| Bleach/Bromide | 0.06 | 0.13 |
| Bromosulfamate/Chlorosulfamate | 0.03 | 0.34 |
| Chlorosulfamate product | 0.02 | 0.80 |
| Chlorinated hydantoin | 0.03 | 0.41 |
| (bleach/5,5-dimethylhydantoin) | | |
| Control (Untreated) | 0.00 | 0.00 |

In order to determine the Trihalomethane concentration of each treated sample, TOC vials were filled with water from each flask, labeled, and analyzed for THM. The results are shown below in Table 5.

TABLE 5
THM Concentration of Halogen Treated Composite Cooling Water

| | Chloro- | Bromo- | Dichloro- | Dibromo- |
|---|---|---|---|---|
| | form | form | bromomethane | chloromethane |
| Sample | (ppb) | (ppb) | (ppb) | (ppb) |
| Cooling Tower | <5 | 53 | <5 | <5 |
| Control | | | | |
| Bleach only | <5 | 99 | <5 | <5 |
| Bleach/Bromide | <5 | 106 | <5 | <5 |
| Bromosulfamate/ | <5 | 82 | <5 | <5 |
| Chlorosulfamate | | | | |
| Chlorosulfamate | <5 | 15 | <5 | <5 |
| product | | | | |
| Chlorinated | <5 | 56 | <5 | <5 |
| hydantoin | | | | |
| (bleach/5,5- | | | | |
| dimethylhydantoin) | | | | |

The results indicated that the untreated cooling water control sample contained bromoform, which suggests that several of the systems that contributed water to the composite sample must have been treated with a bromine-based biocide. The amount of chloroform in all of the samples was below the limit of detection. As expected, the use of a bleach/bromide oxidizing biocide resulted in the highest amount of bromoform, with the stabilized bromine biocide also showing a slight increase in bromoform. The bleach only sample also showed an increase in bromoform, which was likely the result of the reaction of the bleach with residual bromide that was contained in composite cooling water sample. Both the chlorosulfamate and the chlorinated hydantoin treated samples contained less bromoform than the bleach treated sample.

This experiment demonstrated that the use of any of the stabilized halogen biocides (bromosulfamate, chlorosulfamate and the chlorinated hydantoin) reduced the amount of THM's formed when compared to the bleach and bleach/bromide treated samples.

### EXAMPLE 1B

In order to confirm these results, and to determine if they were repeatable, the experiment was again performed as described above. Cooling tower samples were gathered and combined into a composite sample. After thorough mixing, the water was aliquoted into 6 different flasks. The halogen demand for each of the oxidizing biocides was determined for the water, and then each sample was treated with the same oxidizing biocides as noted above to achieve a 1 ppm total halogen residual.

Approximately 3 hours after dosing, the halogen residuals in each sample was measured. The results are shown in the table below.

TABLE 6
Halogen Residuals After First Dose of Oxidizing Biocide

| | Free Halogen | Total Halogen |
|---|---|---|
| Sample | (ppm) | (ppm) |
| Bleach | 0.05 | 0.55 |
| Bleach/Bromide | 0.56 | 0.61 |
| Bromosulfamate/Chlorosulfamate | 0.40 | 0.66 |
| Chlorosulfamate product | 0.02 | 1.17 |
| Chlorinated hydantoin | 0.56 | 0.88 |
| (bleach/5,5-dimethylhydantoin) | | |
| Control (Untreated) | 0.00 | 0.00 |

After 48-hours, the halogen residuals were again determined and shown in the table below.

TABLE 7
Halogen Residuals After First Dose of Oxidizing Biocide

| | Free Halogen | Total Halogen |
|---|---|---|
| Sample | (ppm) | (ppm) |
| Bleach | 0.01 | 0.42 |
| Bleach/Bromide | 0.01 | 0.05 |
| Bromosulfamate/Chlorosulfamate | 0.02 | 0.21 |
| Chlorosulfamate product | 0.01 | 0.96 |
| Chlorinated hydantoin | 0.03 | 0.40 |
| (bleach/5,5-dimethylhydantoin) | | |
| Control (Untreated) | 0.00 | 0.00 |

The samples were again treated with additional oxidizing biocide to increase the total halogen residuals, and approximately 30 minutes after dosing, the halogen residuals were determined as shown in the table below.

TABLE 8
Halogen Residuals Thirty Minutes After
Second Dose of Oxidizing Biocide

| | Free Halogen | Total Halogen |
|---|---|---|
| Sample | (ppm) | (ppm) |
| Bleach | 0.73 | 1.08 |
| Bleach/Bromide | 1.63 | 1.71 |
| Bromosulfamate/Chlorosulfamate | 0.73 | 1.12 |
| Chlorosulfamate product | 0.04 | 1.13 |
| Chlorinated hydantoin | 0.78 | 1.14 |
| (bleach/5,5-dimethylhydantoin) | | |
| Control (Untreated) | 0.00 | 0.00 |

After an additional 48-hours, the halogen residuals were again measured and those results are shown below.

TABLE 9
Halogen Residuals 48-Hours After
Second Dose of Oxidizing Biocide

| | Free Halogen | Total Halogen |
|---|---|---|
| Sample | (ppm) | (ppm) |
| Bleach | 0.01 | 0.83 |
| Bleach/Bromide | 0.45 | 0.52 |
| Bromosulfamate/Chlorosulfamate | 0.03 | 0.36 |
| Chlorosulfamate product | 0.01 | 0.99 |
| Chlorinated hydantoin | 0.03 | 0.58 |
| Control (Untreated) | 0.00 | 0.00 |

In order to determine the Trihalomethane (THM) concentration of each treated sample, TOC vials were filled with water from each flask, labeled, and analyzed for THM. The results are shown below in Table 10.

TABLE 10

| | Chloro- | Bromo- | Dichloro- | Dibromo- |
|---|---|---|---|---|
| | form | form | bromomethane | chloromethane |
| Sample | (ppb) | (ppb) | (ppb) | (ppb) |
| Cooling Tower | <5 | 26 | <5 | <5 |
| Control | | | | |
| Bleach only | <5 | 84 | <5 | 18 |
| Bleach/Bromide | <5 | 259 | <5 | 8 |
| Bromosulfamate/ | <5 | 150 | <5 | 8 |
| Chlorosulfamate | | | | |
| Chlorosulfamate | <5 | 31 | <5 | <5 |
| product | | | | |
| Chlorinated | 7 | 45 | 8 | 20 |
| hydantoin | | | | |
| (bleach/5,5- | | | | |
| dimethylhydantoin) | | | | |

As with the first experiment, the use of the chlorosulfamate biocide and the chlorinated hydantoin resulted in significantly lower bromoform formation than when bleach was used.

### EXAMPLE 2

Blowdown water from an industrial cooling water system was sampled and aliquoted into 6 different flasks. Samples of the blowdown water were used to determine the halogen demand for each biocide that was tested. The oxidizing biocides that were used were bleach; bleach/bromide mixed at a 1:1 mole ratio to achieve complete conversion of the hypochlorite to hypobromous acid; a stabilized bromine biocide that contained a mixture of bromosulfamate and chlorosulfamate; a chlorosulfamate biocide; and a chlorinated hydantoin biocide prepared by mixing a 2:1 mole ratio of 5,5-dimethylhydantoin with sodium hypochlorite (bleach). Each biocide was assayed to determine the concentration of active halogen in the product, and then halogen demands for each product were determined. Once the demands were known, each flask was then treated with sufficient oxidizing biocide to achieve approximately 1 ppm of total halogen and mixed thoroughly. The treated samples, along with the untreated control, were capped and allowed to sit undisturbed on the bench top.

Prior to starting the experiment, a sample of the blowdown water was analyzed for TOC. The TOC content of the water was 10 ppm.

The treated flasks were assayed for both free and total halogen residuals approximately 40 minutes after inoculation using the free and total halogen DPD reagents. Free halogen concentration was measured 30 seconds after addition of the DPD reagent, and total halogen concentration was recorded after 3 minutes. Those results are shown below in Table 11.

TABLE 11
Halogen Residuals Forty Minutes After Dosing

| | Free Halogen | Total Halogen |
|---|---|---|
| Sample | (ppm) | (ppm) |
| Control (no biocide) | 0 | 0 |
| Bleach | 0.53 | 0.74 |
| Bleach/Bromide | 0.57 | 0.60 |
| Bromosulfamate/Chlorosulfamate | 0.50 | 0.75 |
| Chlorosulfamate product | 0.02 | 0.94 |
| Chlorinated hydantoin | 0.61 | 0.80 |
| (bleach/5,5-dimethylhydantoin) | | |

Three days after the initial dosing of the samples, the halogen residuals were again measured. Those results are shown below in Table 12.

TABLE 12
Halogen Residuals Three Days After Initial Dosing

| | Free Halogen | Total Halogen |
|---|---|---|
| Sample | (ppm) | (ppm) |
| Control (no biocide) | 0 | 0 |
| Bleach | 0.01 | 0.10 |
| Bleach/Bromide | 0.00 | 0.03 |
| Bromosulfamate/Chlorosulfamate | 0.00 | 0.14 |
| Chlorosulfamate product | 0.00 | 0.65 |
| Chlorinated hydantoin | 0.08 | 0.18 |
| (bleach/5,5-dimethylhydantoin) | | |

The samples were again dosed with the halogen biocides and residuals were measured approximately one hour after dosing. Those results are shown in Table 13 below.

TABLE 13
Halogen Residuals One Hour After 2^{nd} Dose

| | Free Halogen | Total Halogen |
|---|---|---|
| Sample | (ppm) | (ppm) |
| Control (no biocide) | 0 | 0 |
| Bleach | 0.49 | 0.85 |
| Bleach/Bromide | 0.98 | 1.25 |
| Bromosulfamate/Chlorosulfamate | 0.65 | 0.95 |
| Chlorosulfamate product | 0.01 | 0.91 |
| Chlorinated hydantoin | 0.68 | 0.85 |
| (bleach/5,5-dimethylhydantoin) | | |

After another 72 hours, the halogen residuals of the treated samples were measured, and those results are shown below in Table 14.

TABLE 14
Halogen Residuals Three Days After 2^{nd} Dose

| | Free Halogen | Total Halogen |
|---|---|---|
| Sample | (ppm) | (ppm) |
| Control (no biocide) | 0 | 0 |
| Bleach | 0.00 | 0.15 |
| Bleach/Bromide | 0.01 | 0.05 |
| Bromosulfamate/Chlorosulfamate | 0.01 | 0.23 |
| Chlorosulfamate product | 0.00 | 0.67 |
| Chlorinated hydantoin | 0.06 | 0.14 |
| (bleach/5,5-dimethylhydantoin) | | |

The samples were again dosed with the biocides, and the halogen residuals were measured two hours after the final dose. Those results are shown below in Table 15.

TABLE 15
Halogen Residuals Two Hours After 3rd Dose

| | Free Halogen | Total Halogen |
|---|---|---|
| Sample | (ppm) | (ppm) |
| Control (no biocide) | 0 | 0 |
| Bleach | 0.80 | 1.23 |
| Bleach/Bromide | 1.28 | 1.85 |
| Bromosulfamate/Chlorosulfamate | 0.84 | 1.30 |
| Chlorosulfamate product | 0.00 | 1.12 |
| Chlorinated hydantoin | 0.60 | 1.06 |
| (bleach/5,5-dimethylhydantoin) | | |

In order to determine the THM concentration of each sample, TOC vials were filled with water from each flask, labeled, and then analyzed for THM. The results are shown below in Table 16.

TABLE 16
THM Concentration of Untreated and
Halogen Treated Blowdown Water

| | Chloro- | Bromo- | Dichloro- | Dibromo- |
|---|---|---|---|---|
| | form | form | bromomethane | chloromethane |
| Sample | (ppb) | (ppb) | (ppb) | (ppb) |
| Cooling Tower | 1.68 | <0.2 | 0.341 | 0.205 |
| Control | | | | |
| Bleach only | 64 | 27.9 | 48.4 | 45.6 |
| Bleach/Bromide | 200 | 470 | 8.81 | 31.4 |
| Bromosulfamate/ | 12.9 | 260 | 13.2 | 31.7 |
| Chlorosulfamate | | | | |
| Chlorosulfamate | 13.5 | 0.535 | 2.58 | 1.03 |
| product | | | | |
| Chlorinated | 13.8 | 0.460 | 4.10 | 3.44 |
| hydantoin | | | | |
| (bleach/5,5- | | | | |
| dimethylhydantoin) | | | | |

The results showed that the blowdown water contained a low concentration of the THM's as received. When treated with one of the oxidizing biocides, the concentration of THM's in each of the samples increased, relative to the untreated sample. The amount of chloroform in all of the samples was highest in the bleach/bromide treated sample, whereas the amount in the stabilized bromine biocide, chlorosulfamate product, and chlorinated hydantoin sample were all approximately equivalent. The use of the bleach/bromide oxidizing biocide resulted in the highest amount of bromoform, and the stabilized bromine biocide treated sample also showing an increase in bromoform. Both the chlorosulfamate product and the chlorinated hydantoin treated samples contained less bromoform than the bleach treated sample.

These experiments have demonstrated that the use of several forms of stabilized halogens results in lower concentrations of THM's being produced as compared to the use of bleach or bleach/bromide based biocides.

In the foregoing description, numerous details are set forth to provide an understanding of the present disclosure. However, it may be understood by those skilled in the art that the apparatus of the present disclosure may be practiced without these details and that numerous variations or modifications from the described embodiments may be possible.

Furthermore, the described features, techniques, or characteristics may be combined in any suitable manner in one or more embodiments. In the foregoing description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail. The description is intended only by way of example, and simply illustrates certain example embodiments.

What is claimed is:

1. A method for treating water in a water system in which the water has a total organic carbon (TOC) content of greater than 5 ppm, the method comprising:
combining with the water a sufficient amount of a stabilized halogen biocide that is stabilized with at least one of sulfamic acid and a hydantoin so that the stabilized halogen biocide is present in the water in amounts of from 0.1 to 50 ppm total halogen residual, and
wherein the water that is treated with the stabilized halogen biocide has a total amount of amount of chloroform, bromoform, dichlorobromomethane, and dibromochloromethane that is less than 200 ppb.

2. The method of claim 1, wherein the stabilized halogen biocide includes hypochlorous acid stabilized with dimethylhydantoin.

3. The method of claim 1, wherein the stabilized halogen biocide includes hypobromous acid stabilized with dimethylhydantoin.

4. The method of claim 1, wherein the stabilized halogen biocide includes bromosulfamate.

5. The method of claim 1, wherein the stabilized halogen biocide includes chlorosulfamate.

6. The method of claim 1, wherein the stabilized halogen biocide includes a combination of chlorosulfamate and bromosulfamate.

7. The method of claim 1, wherein a sufficient amount of the stabilized halogen biocide is combined with the water so that the stabilized halogen biocide is present in the water in amounts of from 1 ppm to 5 ppm total halogen residual.

8. The method of claim 7, wherein the water that is treated with the stabilized halogen biocide has a total amount of amount of the chloroform, bromoform, dichlorobromomethane, and dibromochloromethane that is less than 50 ppb.

9. The method of claim 1, wherein the water has a TOC content in a range of from 6 ppm to 50 ppm.

10. The method of claim 1, further comprising combining with the water at least one of hypobromous acid and hypochlorous acid.

11. The method of claim 10, wherein the at least one of hypobromous acid and hypochlorous acid is combined with the water in an amount of less than 1.5 ppm.

12. The method of claim 1, wherein the water system is an open recirculating water system that discharges water to a surface waterway or to a sanitary sewer.

13. The method of claim 1, further comprising measuring an amount of the TOC in the water, and wherein the amount of the stabilized halogen biocide that is combined with the water is based on the measured amount of TOC.

14. The method of claim 1, further comprising determining a demand of the water system for the stabilized halogen biocide.

15. A method for treating water in an open-recirculating water system in which at least one of hypochlorous acid and hypobromous acid are combined with the water as an antimicrobial agent and the water has a first amount of trihalomethanes as chloroform, bromoform, dichlorobromomethane, and dibromochloromethane, the method comprising:
(i) reducing an amount of the hypochlorous acid and/or hypobromous acid that is combined with the water; and
(ii) combining with the water a sufficient amount of a stabilized halogen biocide that is stabilized with at least one of sulfamic acid and a hydantoin so that the stabilized halogen biocide is present in the water in amounts of from 0.1 to 50 ppm total halogen residual, and
wherein the water that is treated with the stabilized halogen biocide has a total amount of the trihalomethanes that is 65% or less than the first amount.

16. The method of claim 15, wherein the first amount is 100 ppb or greater.

17. The method of claim 15, wherein the first amount is 150 ppb or greater.

18. The method of claim 17, wherein the water that is treated with the stabilized halogen biocide has a total amount of the trihalomethanes that is 25% or less than the first amount.

19. The method of claim 15, further comprising measuring an amount of total organic carbon (TOC) in the water, and wherein the amount in which the hypochlorous acid and/or hypobromous acid combined with the water is reduced is based on the measured amount of TOC.
